(19) United States
(12) Patent Application Publication
(10) Pub. No.: US 2020/0051526 A1
(43) Pub. Date: Feb. 13, 2020

(54) BRIGHTNESS ADJUSTMENT METHOD AND RELATED DRIVING DEVICE

(71) Applicant: Wistron Corporation, New Taipei City (TW)

(72) Inventors: Chang-Lin Liou, New Taipei City (TW); Chih-Hao Lo, New Taipei City (TW)

(21) Appl. No.: 16/191,380

(22) Filed: Nov. 14, 2018

(30) Foreign Application Priority Data
Aug. 7, 2018 (TW) 107127386

(51) Int. Cl. G09G 5/10

(52) U.S. Cl. CPC G09G 5/10; G09G 2320/064; G09G 2320/0646; G09G 2330/021; G09G 2320/066; G09G 2320/0606; G09G 2354/00

(57) ABSTRACT

A brightness adjustment method for a display is disclosed. The brightness adjustment method includes determining a first pulse width modulation (PWM) value according to an average picture level (APL) of an image signal; converting the first pulse width modulation value into a second pulse width modulation value according to a converting curve corresponding to a brightness value of the display; and controlling the display to present the image signal with the second pulse width modulation value under the brightness value.

### BACKGROUND OF THE INVENTION

### 1. Field of the Invention

The present invention relates to a brightness adjustment method and related driving device, and more particularly, to a brightness adjustment method and related driving device capable of saving the power consumption of a display.

### 2. Description of the Prior Art

With the advancement and development of technology, many kinds of displays for electronic devices are widely available. For presenting images with higher resolution, a density of the pixel array of the display is increased. Hue shift, white balance shift or color value shift may result from manufacturing differences of displays. Under this situation, a user may activate an On-Screen Display (OSD) interface to manually adjust each parameter of the display, to thereby gradually adjust the display to proper setting values. Alternatively, an auto calibration function of the display might be utilized to calibrate the display picture. Conventional certificate regulations concerning efficiency of the display, such as Energy Star, have become increasingly strict, however. For example, after the display operates for a period of time (e.g. 30 minutes) under a fixed dynamic contrast ratio (DCR), a power consumption of the display should be lower than a specific value (e.g. 20 watts). When the display cannot meet this requirement, the OSD interface cannot be adjusted to meet the certificate regulations. As displays are mass manufactured, when the display cannot conform to the certification regulation requirements, the manufacturer may incur huge losses.

Therefore, how to effectively reduce the power consumption of the display has become an important topic in the field.

### SUMMARY OF THE INVENTION

The present invention provides a brightness adjustment method and related driving device to adjust the brightness value of the display in order to save power consumption and meet certification regulation requirements.

An embodiment of the present invention discloses a brightness adjustment method fora display, comprising: determining a first pulse width modulation (PWM) value according to an average picture level (APL) of an image signal; converting the first pulse width modulation value into a second pulse width modulation value according to a converting curve corresponding to a brightness value of the display; and controlling the display to present the image signal with the second pulse width modulation value under the brightness value.

Another embodiment of the present invention discloses a driving device for a display, comprising: a processor; and a storage device, coupled to the processor, for storing a program code which is configured to instruct the processor to determine a first pulse width modulation value according to an average picture level of an image signal, convert the first pulse width modulation value into a second pulse width modulation value according to a converting curve corresponding to a brightness value of the display, and control the display to present the image signal with the second pulse width modulation value under the brightness value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a driving device according to an embodiment of the present invention.

FIG. 2 is a schematic diagram of a brightness adjustment method according to an embodiment of the present invention.

FIG. 3 is a schematic diagram of a converting curve according to an embodiment of the present invention.

### DETAILED DESCRIPTION

When a dynamic contrast ratio (DCR) function of an on-screen display (OSD) interface of a conventional display is activated, a brightness of the display is unchangeable. Therefore, when power consumption of the display is too high, relative certification regulations will not be passed. The present invention therefore provides a brightness adjustment method to reduce the power consumption of the display when the DCR function of the OSD interface is activated, wherein the certification requirements can be satisfied.

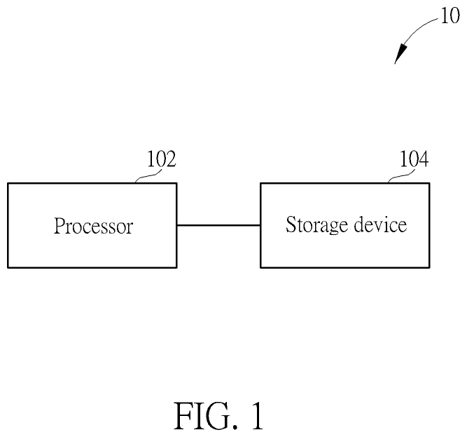

FIG. 1 is a schematic diagram of a driving device 10 according to an embodiment of the present invention. The driving device 10 may be utilized on a display (not depicted in the figure), which includes a processor 102 and a storage device 104. The storage device 104 stores a program code configured to instruct the processor 102 to perform related operations. Since the conventional display is unable to adjust a brightness of the display when the DCR is activated, when power consumption of the display is too high due to manufacturing differences of the display, relative certification might not be passed. Under this situation, an embodiment of the present disclosure provides an adjustment mechanism for the brightness of the display which can adjust the brightness when the DCR function of the display is activated, to thereby reduce power consumption of the display.

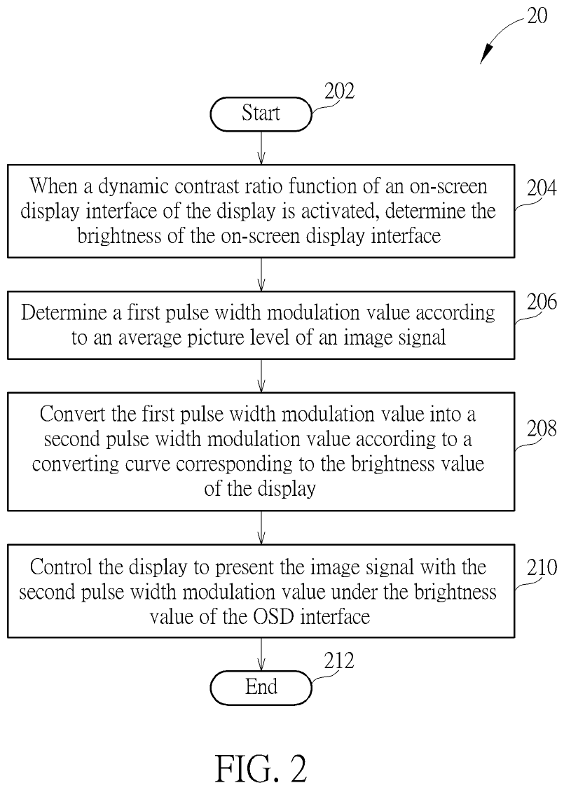

Refer to FIG. 2, which is a schematic diagram of a brightness adjustment method 20 according to an embodiment of the present invention. The brightness adjustment method 20 may be compiled as the program code and stored in the storage device 104 to instruct the processor 102 to perform the related operations. The brightness adjustment method 20 includes the following steps:

Step 202: Start.

Step 204: When a dynamic contrast ratio (DCR) function of an on-screen display (OSD) interface of the display is activated, determine the brightness of the on-screen display interface.

Step 206: Determine a first pulse width modulation (PWM) value according to an average picture level (APL) of an image signal.

Step 208: Convert the first pulse width modulation value into a second pulse width modulation value according to a converting curve corresponding to the brightness value of the display.

Step 210: Control the display to present the image signal with the second pulse width modulation value under the brightness value of the OSD interface.

Step 212: End.

Based on the brightness adjustment method 20, in step 204, when the DCR function of the OSD interface of the display is activated, i.e. under a situation where display contrast is largest, the driving device 10 determines the brightness of the OSD interface. In an embodiment, the brightness value of the OSD interface may be determined by a user. In general, the DCR function of the OSD interface of the display provides different brightness values or brightness ratios, e.g. 0-100 or 0%-100%, for the user to select. When the user selects a higher brightness value or brightness ratio, the display presents an image with higher brightness under a fixed dynamic contrast. When the user selects a lower brightness value or brightness ratio, the display presents an image with lower brightness under the fixed dynamic contrast. Notably, when the OSD interface has different brightness values, the display may present the image signal with the largest contrast.

In step 206, after the driving device 10 determines the brightness value of the OSD interface, the processor 102 determines the first PWM according to the APL of the image signal. In step 208, the processor 102 converts the first PWM value into the second PWM value according to the converting curve corresponding to the brightness value of the display. The APL is related to a display rate of a blank frame, wherein the display rate may be a number or a ratio. When content data of the image signal is close to a blank frame, the display rate is close to 100%. In contrast, when content data of the image signal is close to a black frame, the display rate is close to 0%. The converting curve is relative to an optimal dynamic contrast curve of the display, which is configured to convert the image signal from the first PWM value into the second PWM value.

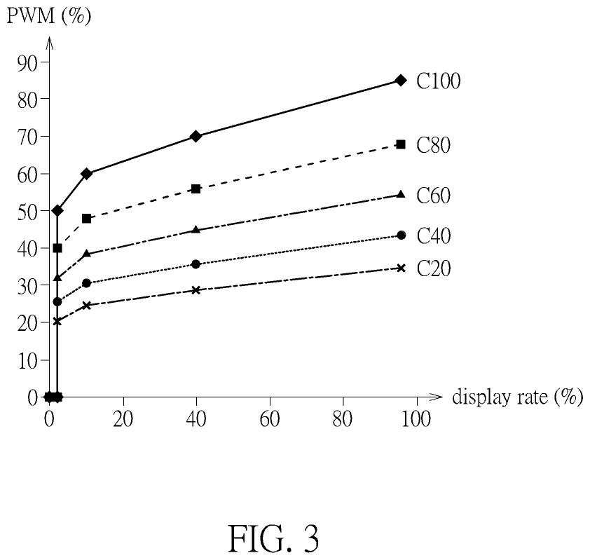

Refer to FIG. 3, which is a schematic diagram of the converting curve according to an embodiment of the present invention. As shown in FIG. 3, different brightness values of the OSD interface may correspond to different converting curves. For example, when the brightness value of the OSD interface is 100, the converting curve C100 is selected for converting the image signal from the first PWM value into the second PWM value. Similarly, when the brightness value of the OSD interface is 80, 60, 40 and 20 respectively, the converting curves C80, C60, C40 and C20 are respectively selected for converting the image signal from the first PWM value into the second PWM value. Notably, the optimal dynamic contrast curve is close to an index curve. In addition, the embodiment stated above only respectively depicts the brightness values 100, 80, 60, 40 and 20 of the OSD interface, but is not limited thereto. Converting curves corresponding to other brightness values or brightness ratios are within the scope of the present invention.

After the processor 102 determines the brightness value of the OSD interface, since the display cannot pass the certification regulations standards with the first PWM value before the brightness adjustment, i.e. the power consumption of the display exceeds the certification regulation requirements, the converting curve in FIG. 3 is adopted for converting the image signal with the original display rate from the first PWM value into the second PWM value. For example, when the brightness value of the OSD interface is 100 and the display rate of the image signal is 60, the second PWM value corresponding to the display rate 60 is 75% of the original first PWM value by adopting the converting curve C100 in FIG. 3. Therefore, in step 210, the driving device 10 drives the display with the second PWM value under the selected brightness value and reduces the power consumption of the display, making the display, which originally does not conform to the power consumption requirement, meet this requirement by adopting the converting curve.

In brief, with the activation of the DCR function of the OSD interface of the display, i.e. under the situation where the display contrast is largest, the driving device 10 converts the display rate of the image signal via the converting curve corresponding to different brightness values after determining the brightness value, so as to reduce power consumption of the display while ensuring the display conforms to the power consumption requirements.

Notably, those skilled in the art may design the driving device based on different system requirements. For example, the converting curve may be determined by different manufacturers or computer systems. Further, the basis for the converting curve is not limited to the display rate of the APL of the image signal, and other information related to the image signal may also be utilized as the basis for the converting curve. The embodiments stated above may all be modified according to the user, requirements of the manufacturer or computer system. These modifications are not limited thereto, and also belong to the scope of the present invention.

In summary, the present invention provides a brightness adjustment method and related driving device to adjust a brightness value of a display for saving power consumption of the display under a situation where display contrast is largest, to thereby conform to the certificate regulation requirements.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A brightness adjustment method for a display, comprising:
determining a first pulse width modulation value according to an average picture level of an image signal;
converting the first pulse width modulation value into a second pulse width modulation value according to a converting curve corresponding to a brightness value of the display; and
controlling the display to present the image signal with the second pulse width modulation value under the brightness value.

2. The brightness adjustment method of claim 1, further comprising:
when a dynamic contrast function of an on screen display (OSD) interface of the display is activated, determining the brightness value of the OSD interface.

3. The brightness adjustment method of claim 2, wherein the brightness value is determined by a user.

4. The brightness adjustment method of claim 1, wherein the average picture level is a display rate of a blank frame.

5. The brightness adjustment method of claim 1, wherein the converting curve corresponding to the brightness value is an optimal dynamic contrast curve of the display.

6. The brightness adjustment method of claim 5, wherein the optimal dynamic contrast curve is similar to an index curve.

7. A driving device for a display, comprising:
a processor; and
a storage device, coupled to the processor, for storing a program code, wherein the program code is configured to instruct the processor to determine a first pulse width modulation value according to an average picture level of an image signal, convert the first pulse width modulation value into a second pulse width modulation value according to a converting curve corresponding to a brightness value of the display, and control the display to present the image signal with the second pulse width modulation value under the brightness value.

8. The driving device of claim 7, wherein when a dynamic contrast function of an on screen display (OSD) interface of the display is activated, the processor determines the brightness value of the OSD interface.

9. The driving device of claim 8, wherein the brightness value is determined by a user.

10. The driving device of claim 7, wherein the average picture level is a display rate of a blank frame.

11. The driving device of claim 7, wherein the converting curve corresponding to the brightness value is an optimal dynamic contrast curve of the display.

12. The driving device of claim 11, wherein the optimal dynamic contrast curve is similar to an index curve.
